(19) United States
(12) Patent Application Publication
(10) Pub. No.: US 2006/0010943 A1
(43) Pub. Date: Jan. 19, 2006

(54) MECHANICAL HANDLE SWITCH ASSEMBLY

(75) Inventors: Robert M. Schmidt, Livonia, MI (US); Mark G. Feldman, Farmington Hills, MI (US)

Correspondence Address: JOHN A. ARTZ, ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/710,454

(22) Filed: Jul. 13, 2004

(51) Int. Cl. E05B 65/12

(52) U.S. Cl. 70/257

(57) ABSTRACT

A mechanical handle switch assembly (14) (“switch assembly”) is provided for actuating a vehicle-based system (12). The switch assembly (14) includes a door handle mechanism (28), which is coupled to a vehicle door (26) and utilized for actuation by a user. This door handle mechanism (28) is movable a predetermined travel distance, which includes a switch-triggering distance for actuating the vehicle-based system (12) and an unlatching distance for unlatching the vehicle door (26). The door handle mechanism (28) is coupled to a drive train mechanism (34) and utilized for actuating the drive train mechanism (34). The drive train mechanism (34) is operatively coupled to a switch device (18) for selectively closing the switch device (18) and actuating the vehicle-based system (12).

### BACKGROUND OF INVENTION

The present application relates to another application entitled “MECHANICAL HANDLE SWITCH ASSEMBLY WITH A DAMPENING MECHANISM,” filed herewith.

The present invention relates generally to door handle switch assemblies, and more particularly to a mechanical handle switch assembly having a simple robust construction for ease of manufacture, efficient installation, low power consumption, and substantially low costs associated therewith.

Passive entry systems for providing access to the interior of a vehicle are well known. A typical passive entry system utilizes radio frequency identification technology. One known passive entry system includes a vehicle-based transceiver and a portable transponder, which is carried by an authorized user. This system typically includes an electronic sensor for detecting the actuation of a door handle by an individual who intends to enter the vehicle. In this regard, the electronic sensor can detect door handle acutation and trigger the vehicle-based transceiver to transmit a challenge signal or random number to the portable transponder. The portable transponder typically utilizes an encryption key for encrypting the random number and producing a challenge response signal for transmission to the vehicle-based transceiver.

While the portable transponder processes the challenge signal, the vehicle-based transceiver typically utilizes an encryption key for encrypting the same random number, and producing an expected response. In this way, the vehicle-based transceiver typically receives the challenge response signal from the portable transponder and compares the challenge response signal to the expected response. If the challenge response signal matches the expected response, then the vehicle-based transceiver typically actuates a locking mechanism for unlocking the vehicle door.

It would therefore be desirable to provide a door handle switch assembly having a simple robust construction for ease of manufacture, efficient installation, low power consumption, and substantially low costs associated therewith.

### SUMMARY OF INVENTION

In one advantageous embodiment of the claimed invention, a mechanical handle switch assembly (“switch assembly”) is provided for actuating a vehicle-based system.

The switch assembly includes a door handle, which is coupled to a vehicle door. This door handle is movable a predetermined travel distance, which includes a switch-triggering distance for actuating the vehicle-based system and an unlatching distance for unlatching the vehicle door. The door handle is coupled to a drive train mechanism and utilized for actuating the drive train mechanism.

The drive train mechanism is operatively coupled to a switch device for selectively closing the switch device and actuating the vehicle-based system.

One advantage of the present invention is that a switch assembly is provided that can detect actuation of a door handle within a substantially short period of time so as to trigger a vehicle-based system and provide the vehicle-based system with sufficient processing time for performing an action.

Another advantage of the present invention is that a switch assembly is provided that has a robust construction for substantially decreasing the risk of malfunction.

Yet another advantage of the present invention is that a switch assembly is provided that does not require electrical power for detecting actuation of a door handle and therefore is energy efficient.

Still another advantage of the present invention is that a mechanical handle switch assembly is provided that has a simple construction for providing ease of manufacture and installation and for decreasing costs associated therewith.

Other advantages of the present invention will become apparent when viewed in light of the detailed description of the invention when taken in conjunction with the attached drawings and appended claims.

### BRIEF DESCRIPTION OF DRAWINGS

For a more complete understanding of this invention, reference should now be made to the embodiments illustrated in greater detail in the accompanying drawings and described below by way of examples of the invention:

FIG. 1 is a perspective view of a vehicle having a vehicle based system with a mechanical handle switch assembly (“switch assembly”) integrated within a vehicle door, according to one advantageous embodiment of the claimed invention;

FIG. 2 is a side elevation view of the switch assembly shown in FIG. 1, as taken along line 2-2, illustrating the switch assembly having a lift configuration and being disposed in a rest position;

FIG. 3A is a side elevation view of the switch assembly shown in FIG. 1, as taken along line 2-2, illustrating the switch assembly having a lift configuration and being moved to a switch-triggering position for triggering the vehicle-based system;

FIG. 3B is a side elevation of the switch assembly shown in FIG. 1, as taken along line 2-2, illustrating the switch assembly having a lift configuration and being moved to an unlatching position for unlatching the door;

FIG. 4 is a top elevation view of the switch assembly shown in FIG. 1, as taken along perspective arrow 4, illustrating the switch assembly having a pull configuration and being disposed in a rest position, according to another embodiment of the claimed invention;

FIG. 5A is a top elevation view of the switch assembly shown in FIG. 1, as taken along perspective arrow 4, illustrating the switch assembly having a pull configuration and being moved to a switch-triggering position for triggering the vehicle-based system, according to another embodiment of the invention;

FIG. 5B is a top elevation view of the switch assembly shown in FIG. 1, as taken along perspective arrow 4, illustrating the switch assembly having a pull configuration and being moved to an unlatching position for unlatching the door, according to another embodiment of the invention;

FIG. 6 is a top cutaway view of the switch assembly shown in FIG. 4, illustrating the switch assembly having a dampening mechanism with gas compression coupling, according to another advantageous embodiment of the claimed invention; and

FIG. 7 is a top cutaway view of the switch assembly shown in FIG. 4, illustrating the switch assembly having a dampening mechanism with a viscous fluid coupling, according to yet another advantageous embodiment of the claimed invention.

### DETAILED DESCRIPTION

In the following figures, the same reference numerals are used to identify the same components in the various views. The illustrated embodiments described herein employ features where the context permits, e.g. when a specific result or advantage of the claimed invention is desired. Specifically, the embodiments described herein utilize a mechanical handle switch assembly (“switch assembly”) for a passive entry system of a vehicle. However, it is contemplated that the switch assembly can be utilized for various other systems and other structures instead of vehicles, e.g. buildings. In other words, a variety of embodiments are contemplated having different combinations of the described features, having features other than those described herein, or lacking one or more of those features. For these reasons, it is understood that the invention can be carried out in various suitable modes.

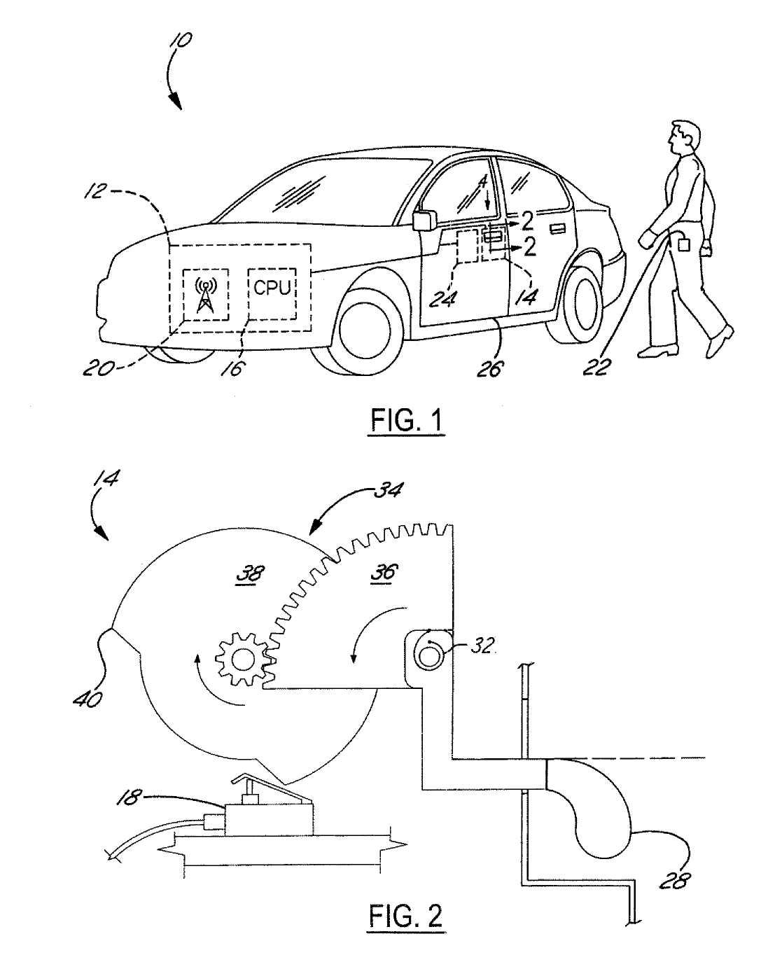

Referring to FIG. 1, there is shown a perspective view of a vehicle 10 having a passive entry system 12 with a switch assembly 14, according to one advantageous embodiment of the claimed invention. The passive entry system 12 further includes a controller 16, which is coupled to and actuated by the switch device 18. The controller 16 utilizes a transceiver 20 for transmitting a challenge signal or random number to a portable transponder 22 that is carried by an authorized user. The portable transponder 22 utilizes an encryption key to encrypt the challenge signal so as to produce a challenge response signal for transmission to the transceiver 20. Likewise, the controller 16 utilizes an encryption key to encrypt the challenge signal and produce an expected response. The controller 16 determines whether the challenge response signal matches the expected response. If the challenge response signal matches the expected response, then the controller 16 actuates a locking mechanism 24 to unlock the vehicle door 26 and allow the door handle 28 to unlatch the vehicle door from its closed position. However, if the challenge response signal does not match the expected response, then the locking mechanism 24 maintains the vehicle door 26 in a latched and locked state.

It will be appreciated that the passive entry system 12 requires a minimum processing time period for performing the aforementioned steps and authorizing a person to access the interior of vehicle. As detailed in the description for FIGS. 2-5B, the switch assembly 14 is utilized for providing the passive entry system 12 with sufficient processing time to unlock the vehicle door 26 before the person moves the door handle 28 to the unlatched position.

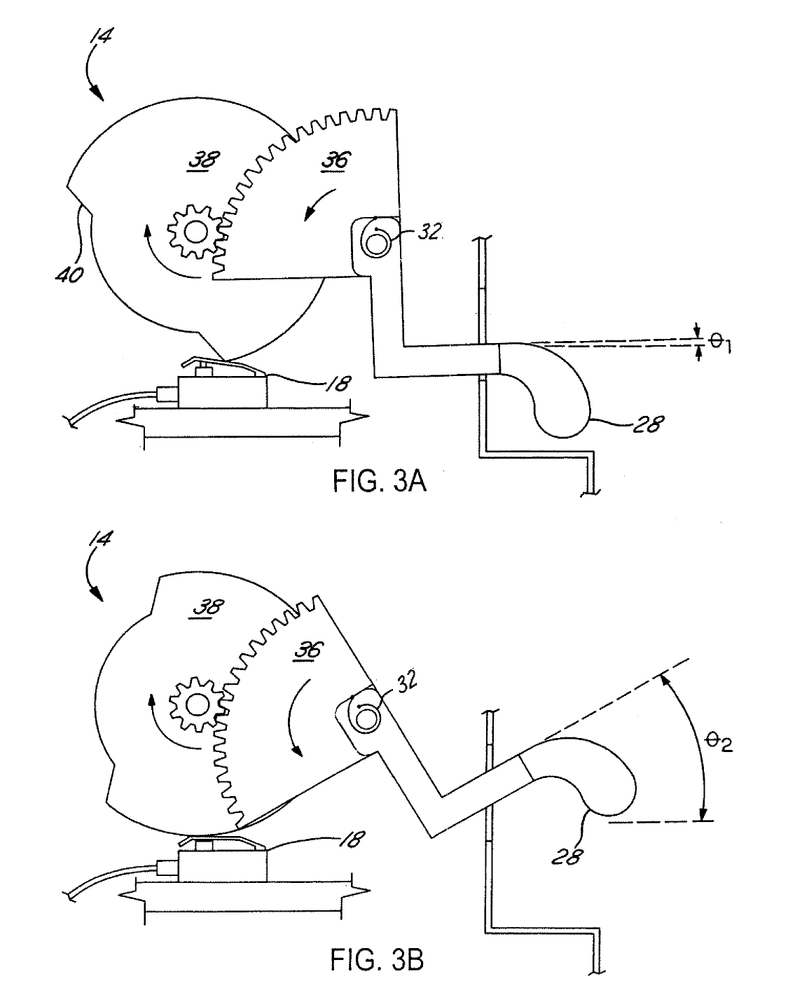

Referring now to FIGS. 2-3B, there are shown side elevation views of the switch assembly 14 shown in FIG. 1, illustrating a sequence of operating the switch assembly 14. FIG. 2 illustrates the switch assembly 14 in a rest position. Additionally, FIGS. 3A and 3B show the switch assembly 14 being moved respectively to a switch-triggering position for actuating the vehicle-based system 30 and an unlatching position for unlatching the vehicle door 26.

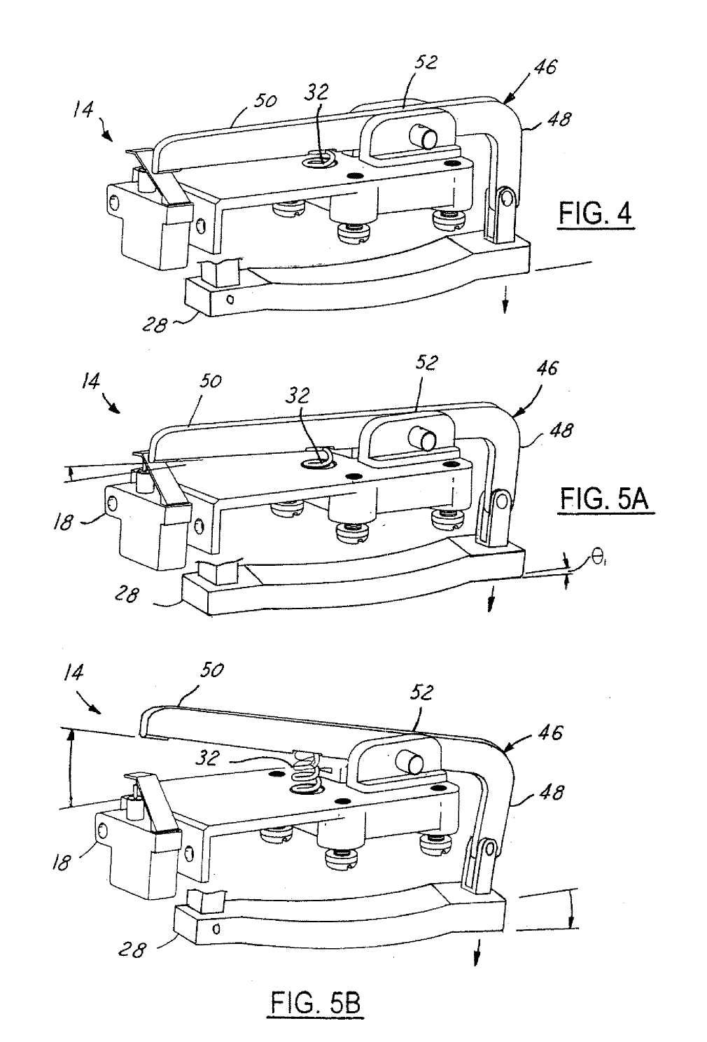

The switch assembly 14 includes a door handle 28 coupled to a vehicle door 26. In this embodiment, the door handle 28 has a lift configuration for being pivoted upward. However, as detailed in the description for FIGS. 4A-5B, the door handle 28 can have various other suitable configurations, e.g. a pull configuration for being pulled outboard from the vehicle door 26. Referring to FIG. 3, the door handle 28 is biased to a latched position via a biasing member 32. This biasing member 32 is a torsional spring. However, it is understood that the biasing member 32 can instead be a variety of other suitable biasing members as desired.

The door handle 28 is coupled to a drive train mechanism 34 for actuating the drive train mechanism 34 when a user moves the door handle 28. Furthermore, the drive train mechanism 34 is coupled to a normally open switch device 18 for contacting and closing the switch device 18 when the drive train mechanism 34 is actuated by the door handle 28. Moreover, this switch device 18 is coupled to the passive entry system 12 for triggering the passive entry system 12 when the switch device 18 is closed. In this way, it will be appreciated that operating the door handle 28 triggers the switch device 18 and actuates the passive entry system 12. One skilled in the art will understand that this simple construction is beneficial for providing ease of manufacture and installation within a vehicle door, as well as minimizing costs associated therewith. In addition, the robust construction substantially decreases the risk of malfunction and does not require an electrical source of power for detecting handle operation by a user.

In the embodiment shown in FIGS. 2-3B, the drive train mechanism 34 is comprised of a first gear member 36 coupled to the door handle 28, a second gear member 38 operatively coupled to the first gear member 36, and a cam member 40 integrated within the second gear member 38. However, as exemplified in FIGS. 4A-5B, it will be appreciated that the drive train 42 can have various other suitable constructions as desired.

As best shown in FIG. 3A, the gear ratio between the first gear member 36 and the second gear member 38 is sufficiently high for triggering the switch device 18 with substantially little movement of the door handle 28. Specifically, the door handle 28 is movable a predetermined travel distance, which includes a switch triggering distance (shown in FIG. 3A) and an unlatching distance (shown in FIG. 3B). Moving the door handle 28 by the switch-triggering distance closes the switch device 18 and triggers the passive entry system 12. Moreover, moving the door handle 28 by the unlatching distance causes the door 26 to be unlatched and swung open. In this embodiment, the unlatching distance is substantially greater than the switch-triggering distance. One skilled in the art will understand that this feature provides a substantially high amount of time from the moment from when the switch device 18 is triggered to the moment when the vehicle door 26 is unlatched. This feature is beneficial for providing the passive entry system 12 with sufficient processing time for verifying the authorization of the user and actuating the locking device 44 to unlock the vehicle door 26 before the user moves the door handle 28 to the unlatching position.

Referring now to FIGS. 4-5B, there is shown the switch assembly 14, according to another embodiment of the claimed invention. As mentioned hereinabove, this switch assembly 14 includes a door handle 28 with a pull configuration where the handle is movable in a substantially outboard direction of the vehicle. In addition, the drive train mechanism 34 is a lever arm 46 having a force arm portion 48 coupled to the door handle 28, a resistance arm portion 52 operatively coupled to a normally closed switch device 18, and a fulcrum portion 52 disposed between the force arm portion 48 and the resistance arm portion 52. One skilled in the art will understand that in the rest position (as shown in FIG. 4) a biasing member 32 actuates the lever 46 to contact the switch device 18 and open the normally-closed switch device. Moreover, actuation of the door handle 28 moves the lever 46 away from the switch device 18 thereby allowing the normally-closed switch device 18 to close.

The force arm portion 48 is substantially shorter than the resistance arm portion 52. In this way, the lever 46 triggers the switch device 18 with substantially little movement of the door handle 28. In other words, the switch assembly 14 provides a substantially high amount of time between the moment the switch device 18 is triggered and the moment the vehicle door 26 is unlatched. This feature is beneficial for providing the passive entry system 12 with sufficient processing time for verifying the authorization of the user and actuating the locking device to unlock the vehicle door 26 before the user moves the door handle 28 to the unlatching position.

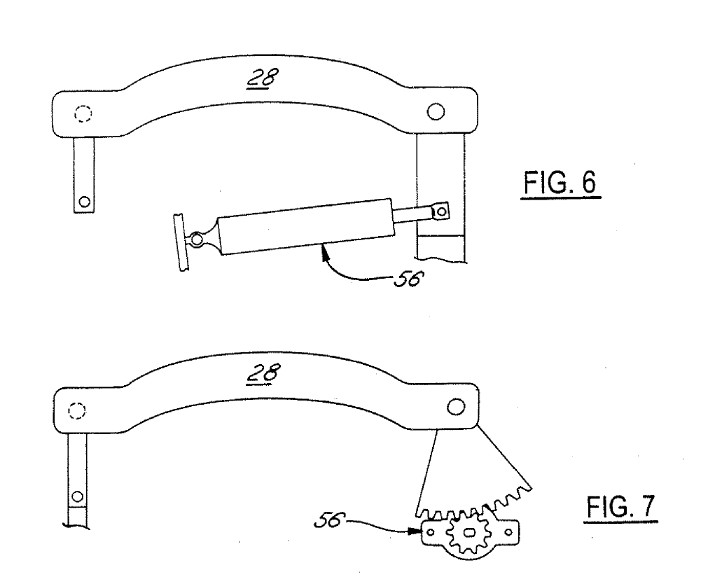

Referring now to FIG. 6, there is shown a top view of the switch assembly 14 shown in FIG. 4, according to yet another advantageous embodiment of the claimed invention. This switch assembly 14 includes a dampening mechanism 56 coupled to the door handle 28 for decreasing the speed by which the door handle 28 is moved by the user. In this regard, the dampening mechanism 56 further increases the amount of time required to move the handle 28 from the switch-triggering position to the unlatching position. In this regard, the passive entry system 12 has additional processing time for verifying the authorization of the user and actuating the locking mechanism 24 to unlock the door 58 before the user moves the handle 60 to the unlatched position.

In the embodiment shown in FIG. 6, the dampening mechanism 56 is a gas compression device. However, as exemplified in FIG. 7, the dampening mechanism 56 can instead be a viscous fluid coupling or various other suitable dampening mechanisms as desired.

In addition, it will be appreciated that the dampening mechanism 56 can be configured to resist movement of the door handle 28 only between the switch-triggering position and the unlatching position.

While particular embodiments of the invention have been shown and described, numerous variations and alternate embodiments will occur to those skilled in the art. Accordingly, it is intended that the invention be limited only in terms of the appended claims.

1. A mechanical handle switch assembly integrated within a door of a vehicle and utilized for actuating a vehicle-based system, comprising:
a door handle mechanism coupled to the door for actuation by a user, said door handle mechanism being movable for actuating the vehicle-based system and unlatching the door;
a drive train mechanism coupled to said door handle mechanism and being actuated by said door handle mechanism; and
a switch device operatively coupled to said drive train mechanism and being selectively closed by said drive train mechanism.

2. The mechanical handle switch assembly recited in claim 1 wherein said door handle mechanism is movable within a predetermined travel distance, said door handle mechanism actuating said drive train mechanism and closing said switch device when said door handle mechanism is moved a substantially small portion of said predetermined travel distance.

3. The mechanical handle switch assembly recited in claim 1 wherein said door handle mechanism is movable within a predetermined travel distance, said predetermined travel distance including a switch-triggering distance and an unlatching distance that is greater than and inclusive of said switch-triggering distance, said door handle mechanism being moved by said switch-triggering distance for actuating said switch device, said door handle mechanism being moved by said unlatching distance for unlatching the door.

4. The mechanical handle switch assembly recited in claim 1 wherein said door handle mechanism has a pull configuration for unlatching the door.

5. The mechanical handle switch assembly recited in claim 1 wherein said door handle mechanism has a lift configuration for unlatching the door.

6. The mechanical handle switch assembly recited in claim 1 wherein said drive train mechanism is a gear mechanism.

7. The mechanical handle switch assembly recited in claim 1 wherein said drive train mechanism is a cam mechanism.

8. The mechanical handle switch assembly recited in claim 1 wherein said drive train mechanism is a lever mechanism.

9. The mechanical handle switch assembly recited in claim 1 wherein said switch device is biased to an open position.

10. A passive entry system for a vehicle comprising:
a controller;
a vehicle-based transceiver coupled to said controller;
a portable transponder carried by a user and utilized for communicating with said vehicle based transponder;
a switch device coupled to one of said controller and said vehicle-based transceiver, said switch device for actuating said vehicle-based transceiver to transmit a challenge signal to said portable transponder;
a drive train mechanism coupled to said switch device for closing said switch device;
a door handle mechanism coupled to the door for actuation by a user, said door handle mechanism being movable within a predetermined distance including a switch-triggering distance and an unlatching distance that is greater than and inclusive of said switch-triggering distance, said switch-triggering distance for triggering said switch device and actuating said controller for determining whether said user is authorized to enter the vehicle, said unlatching distance for providing access to the vehicle;
a locking mechanism coupled to and actuated by said controller, said locking mechanism for unlocking said door when said controller determines that said user is an authorized entity and before said door handle mechanism has moved by said unlatching distance.

11. The passive entry system recited in claim 10 wherein said switch-triggering distance is substantially less than said unlatching distance.

12. The passive entry system recited in claim 10 wherein said door handle mechanism has a pull configuration for unlatching the door.

13. The passive entry system recited in claim 10 wherein said door handle mechanism has a lift configuration for unlatching the door.

14. The passive entry system recited in claim 10 wherein said drive train mechanism is a gear mechanism.

15. The passive entry system recited in claim 10 wherein said drive train mechanism is a cam mechanism.

16. The passive entry system recited in claim 10 wherein said drive train mechanism is a lever mechanism.

17. The passive entry system recited in claim 10 wherein said switch device is biased to an open position.

18. A passively-actuated vehicle system comprising:
a controller;
a vehicle-based transceiver coupled to said controller;
a portable transponder carried by a user and utilized for communicating with said vehicle based transponder;
a switch device coupled to one of said controller and said vehicle-based transceiver, said switch device for actuating said vehicle-based transceiver to transmit a challenge signal to said portable transponder;
a drive train mechanism coupled to said switch device for closing said switch device;
a door handle mechanism coupled to the door for actuation by a user, said door handle mechanism for providing access to the vehicle; and
a locking mechanism coupled to said controller for actuation by said controller, said locking mechanism for unlocking said door after said controller determines that said user is an authorized entity.

19. The passively-actuated vehicle system recited in claim 1 wherein said door handle mechanism coupled to the door for actuation by a user, said door handle mechanism being movable within a predetermined distance including a switch-triggering distance and an unlatching distance that is greater than and inclusive of said switch-triggering distance, said switch-triggering distance for triggering said switch device and said unlatching distance for providing access to the vehicle.

20. The passively-actuated vehicle system recited in claim 1 wherein said drive train mechanism is at least one of a gear mechanism, a cam mechanism, and a lever mechanism.
